(19) United States
(12) Patent Application Publication
(10) Pub. No.: US 2026/0288049 A1
(43) Pub. Date: Sep. 24, 2026

(54) IMAGE FORMING APPARATUS

(71) Applicant: CANON KABUSHIKI KAISHA, Tokyo (JP)

(72) Inventors: KOICHIRO MASUI, Shizuoka (JP); SHUN SATO, Kanagawa (JP); ATSUSHI TODA, Shizuoka (JP); TAKU WATANABE, Shizuoka (JP)

(21) Appl. No.: 19/561,302

(22) Filed: Mar. 9, 2026

(30) Foreign Application Priority Data
Mar. 18, 2025 (JP) 2025-044140

(51) Int. Cl. G03G 15/00; G03G 15/20

(52) U.S. Cl. CPC G03G 15/6585; G03G 15/2039; G03G 15/2064; G03G 15/657; G03G 15/6573; G03G 15/6579; G03G 2215/00877

(57) ABSTRACT

An image forming apparatus includes a transfer unit configured to transfer a powder adhesive image to a sheet, a fixing unit configured to fix a powder adhesive image that has been transferred to a sheet by the transfer unit by applying heat to the powder adhesive image, and a folding unit configured to fold a sheet having passed through the fixing unit. The image forming apparatus further includes a conveyance path configured to convey a sheet on which a powder adhesive image has been fixed to the fixing unit after the sheet has passed through the folding unit, and a folded sheet that has been conveyed to the fixing unit through the conveyance path is heated by the fixing unit, so that the powder adhesive image fixed to the sheet develops adhesiveness to adhere surfaces of the folded sheet to each other.

### BACKGROUND

### Field of the Technology

The present disclosure relates to an image forming apparatus for adhering a sheet with a powder adhesive through an electrophotographic method.

### Description of the Related Art

Conventionally, in a case where a document is to be sealed, such as a pressure-sealed postcard, which contains confidential information, is to be created, an image forming apparatus capable of outputting a product with sealed confidential information through an electrophotographic method using printer toner and powder adhesives has been proposed in Japanese Patent Laid-Open No. 2007-193004. The apparatus described in Japanese Patent Laid-Open No. 2007-193004 prints information on a sheet by using printer toner, and applies a powder adhesive to an area expected to be adhered. The apparatus then fixes the printer toner and the powder adhesive to the sheet through a fixing unit. Thereafter, the apparatus folds the sheet with a sheet folding unit and executes adhesive processing. In the adhesive processing, the apparatus develops adhesiveness of the powder adhesive by applying heat and pressure to the sheet through a heating roller pair and adheres the folded sheet surfaces together.

As described in Japanese Patent Laid-Open No. 2007-193004, when the image forming apparatus capable of creating a pressure-sealed postcard includes two heating units such as the fixing unit and the heating roller pair, the size of the image forming apparatus may increase.

### SUMMARY

The present disclosure is directed to an image forming apparatus capable of creating a pressure-sealed postcard or the like without increasing the size of the apparatus.

According to some embodiments of the present disclosure, an image forming apparatus includes a transfer unit configured to transfer a powder adhesive image to a sheet, a fixing unit configured to fix a powder adhesive image that has been transferred to a sheet by the transfer unit by applying heat to the powder adhesive image, and a folding unit configured to fold a sheet having passed through the fixing unit. The image forming apparatus further includes a conveyance path configured to convey a sheet on which a powder adhesive image has been fixed to the fixing unit after the sheet has passed through the folding unit, and a folded sheet conveyed to the fixing unit through the conveyance path is heated by the fixing unit, so that the powder adhesive image fixed to the sheet develops adhesiveness to adhere surfaces of the folded sheet to each other.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a sheet adhering apparatus according to a first embodiment.

FIG. 2 is a block diagram illustrating a control unit according to the first embodiment.

FIG. 3 is a schematic diagram illustrating a process cartridge according to the first embodiment.

FIGS. 4A to 4F are diagrams illustrating details of folding processing according to the first embodiment.

FIGS. 5A to 5C are diagrams illustrating examples of adhered products output from the sheet adhering apparatus according to the first embodiment.

FIGS. 6A and 6B are schematic diagrams illustrating a return conveyance path according to the first embodiment.

FIG. 7 is a schematic diagram illustrating a sheet adhering apparatus according to a second embodiment.

FIGS. 8A and 8B are schematic diagrams illustrating a pressure value changing apparatus according to a fifth embodiment.

### DESCRIPTION OF THE EMBODIMENTS

Hereinafter, various exemplary embodiments, features, and aspects of the present disclosure are described in detail with reference to the drawings. Dimensions, materials, shapes, and relative arrangements of the constituent elements described in the below-described embodiments are not intended to limit the scope of the present disclosure, unless such limitations are described in particular.

Further, unless otherwise specified, materials, shapes and the like of the members described once are considered to be consistent throughout the subsequent descriptions.

### First Embodiment

### General Configuration of Apparatus

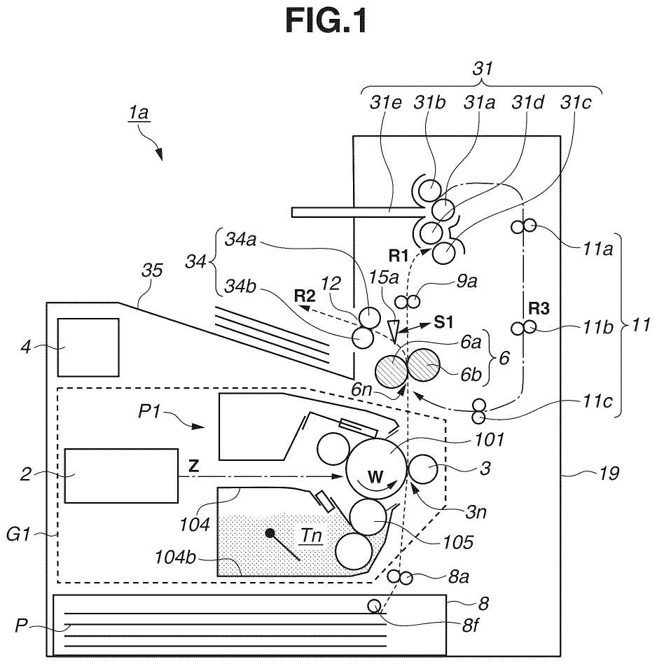

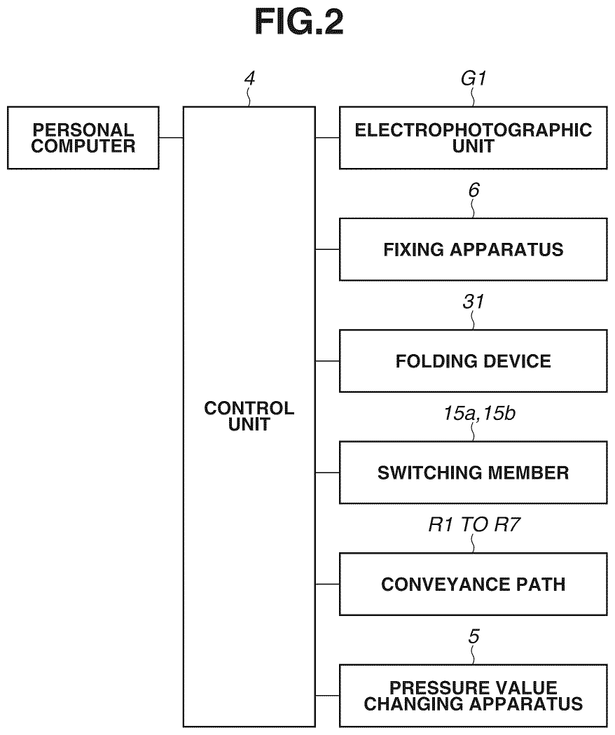

First, a general configuration of a sheet adhering apparatus 1a will be described with reference to FIGS. 1 and 2, where FIG. 1 is a schematic diagram illustrating a cross-sectional configuration of the sheet adhering apparatus 1a according to a first embodiment. As described below, the sheet adhering apparatus 1a has a configuration similar to a configuration of an electrophotographic image forming apparatus, except that the sheet adhering apparatus 1a uses a powder adhesive as developer. FIG. 2 is a schematic diagram illustrating main parts of a control system according to the present embodiment. A controller or control unit 4 controls an electrophotographic unit G1 to form an image on a sheet P based on image data received from an external apparatus such as a personal computer. Although details are described below, the control unit 4 controls various operations by communicating with a fixing apparatus 6 and a folding device 31 as well as by communicating with a switching member 15a and a conveyance path R3.

First, an internal configuration of the sheet adhering apparatus 1a will be described. As illustrated in FIG. 1, the sheet adhering apparatus 1a includes a sheet cassette 8 serving as a sheet storage unit that stores sheets P to be processed through adhesive processing, an electrophotographic unit G1 that applies the powder adhesive Tn to a sheet P, and a fixing apparatus 6 serving as a fixing unit. The sheet adhering apparatus 1a further includes a switching member 15a that switches a conveyance path of a sheet P, a folding device 31 that folds a sheet P, a conveyance path R3 serving as a return conveyance path through which the folded sheet P returns to the fixing apparatus 6, the control unit 4 that controls the above-described constituent elements, and a housing 19 in which all of these constituent elements are housed.

The sheet adhering apparatus 1a has a function for executing fixing processing. In the fixing processing, the electrophotographic unit G1 applies a powder adhesive Tn to a sheet P fed from the sheet cassette 8, and the fixing apparatus 6 fixes the powder adhesive Tn to the sheet P. The sheet P in the first embodiment is standard paper or thin paper having a basis weight of 100 grams per meter squared (g/m²) or less, and preprinted paper is set on which information is previously printed through various printing methods, such as an electrophotographic method, an inkjet printing method, and an offset printing method. The sheet adhering apparatus 1a according to the present embodiment creates an adhered product by applying only the powder adhesive Tn to the preprinted paper. Thus, the sheet adhering apparatus 1a can also be referred to as a pressure-sealing apparatus.

The sheet cassette 8 is inserted to a housing 19 on the lower side of the sheet adhering apparatus 1a in a drawable state, and a large number of sheets P are stored in the sheet cassette 8. The sheets P stored in the sheet cassette 8 are fed from the sheet cassette 8 by a feeding roller 8f and conveyed by conveyance rollers 8a in a state of being separated from each other by a separation roller pair (not illustrated). The feeding roller 8f is an example of a feeding member for feeding a sheet P, and a feeding mechanism may also be used in which an endless belt on which ventilation holes are formed is provided to absorb and feed the sheet P with negative pressure generated by an air suctioning unit. The separation roller pair includes a conveyance roller for conveying a sheet P and a separation roller. The separation roller is supported by a fixing shaft via a torque limiter, so as to be in contact with the conveyance roller. The separation roller applies a frictional force to sheets P at a nip portion (separation nip) between the conveyance roller and the separation roller, so that the sheets P, other than a sheet P that is in contact with the conveyance roller, are prevented from being conveyed in an overlapping state. In addition, for example, a friction pad member may also be used as the mechanism for separating the sheets P as well as using the separation roller.

The electrophotographic unit G1, which is controlled by the control unit 4, is an electrophotographic mechanism including a process cartridge P1, a scanner unit 2, and a transfer roller 3. The electrophotographic unit G1 functions as an adhesive application unit that applies the powder adhesive Tn to a sheet P through electrophotographic processing using the powder adhesive Tn as developer. A process cartridge is a replaceable unit in which a plurality of components for executing electrophotographic processing is integrated. The sheet adhering apparatus 1a includes a cartridge supporting portion (not illustrated) supported by the housing 19, and the process cartridge P1 is mounted on the sheet adhering apparatus 1a in a removable state.

The process cartridge P1 is configured of a photosensitive unit CC that includes a photosensitive drum 101 serving as an image bearing member and a development unit DT that includes a powder containing unit 104 and a development roller 105 for executing development by using a powder. Details will be described below. Further, the sheet adhering apparatus 1a according to the present embodiment is not only capable of developing a printer-toner image (color-toner image) on the image bearing member, but also capable of developing a transparent image with the powder adhesive Tn from an electrostatic latent image formed on the image bearing member. In addition, the powder adhesive Tn does not have to be transparent. In the powder containing unit 104, the powder adhesive Tn (powder adhesive or adhesive toner) serving as a powder used for executing adhesive processing on the sheet P is contained.

The scanner unit 2 functions as an exposure unit for writing an electrostatic latent image on the photosensitive drum 101 of the process cartridge P1 by irradiating the photosensitive drum 101 with laser light Z. The transfer roller 3 faces the photosensitive drum 101 of the process cartridge P1 to form a transfer nip 3n serving as a transfer portion together with the photosensitive drum 101. The transfer roller 3 functions as a transfer unit for transferring an image formed of the powder adhesive Tn and a colored toner image from the photosensitive drum 101 to the sheet P fed from the sheet cassette 8 at the transfer nip 3n.

The fixing apparatus 6 serving as a fixing unit is arranged on the upper side of the transfer roller 3 and controlled by the control unit 4. The fixing apparatus 6 is a heat fixation-type fixing device that includes a heating roller 6a serving as a heating unit and a pressure roller 6b serving as a pressure member. The heating roller 6a is heated by a heat generation member or an induction heating-type heat generation mechanism such as a halogen lamp or a ceramic heater. The pressure roller 6b is pressed against the heating roller 6a by a biasing member such as a spring, and the pressure roller 6b generates a pressure force for applying pressure to a sheet P passing through a nip portion (fixing nip 6n) between the heating roller 6a and the pressure roller 6b. Herein, the fixing apparatus 6 that holds and conveys a sheet P with a roller pair as a pair of rotation members has been described. However, for example, a thermal film-type fixing device may also be used as the fixing apparatus 6. The thermal film-type fixing device includes a cylindrical film, which includes a heater having a heat-generating resistor arranged on the inner side, and a pressure roller pressed against and being in contact with the heater across the film. Then, the thermal film-type fixing device fixes an image on a sheet by holding the sheet at a nip portion between the pressure roller and the film.

The sheet adhering apparatus 1a includes the folding device 31 serving as a sheet folding unit, arranged on the upper side of the fixing apparatus 6. As illustrated in FIG. 1, in the present embodiment, the folding device 31 is arranged to overlap with the fixing apparatus 6 when viewed from the gravitational direction. Further, conveyance rollers 9a for conveying a sheet P having passed through the fixing apparatus 6 to the folding device 31 are attached, and a conveyance path R1 for conveying the sheet P to the folding device 31 is formed. The folding device 31 is controlled by the control unit 4 to create a folded sheet P by folding the sheet P. Functions included in the folding device 31 will be described below.

In contrast, a discharge port 12 serving as an opening portion for discharging a sheet P from the sheet adhering apparatus 1a is arranged on the sheet adhering apparatus 1a, and a discharge unit 34 is arranged on the discharge port 12. The discharge unit 34 serving as a discharge unit of the present embodiment includes a first discharge roller 34a and a second discharge roller 34b. A sheet P discharged from the sheet adhering apparatus 1a is held by the first and the second discharge rollers 34a and 34b, discharged from the discharge port 12, and stacked on the discharge tray 35. At this time, a path through which the sheet P is discharged from the discharge port 12 is referred to as a conveyance path R2.

In the sheet adhering apparatus 1a, a switching member 15a for switching a conveyance destination of a sheet P having passed through the fixing apparatus 6 is arranged. The switching member 15a is arranged at a branch portion of the conveyance path R1 and the conveyance path R2. The switching member 15a is controlled by the control unit 4 to switch the conveyance destination of the sheet P by rotating about a rotation shaft (not illustrated) in a direction S1 in FIG. 1.

The switching member 15a switches a conveyance destination of a sheet P having passed through the fixing apparatus 6, so that the sheet P is firstly conveyed to the conveyance path R1. Thereafter, the sheet P is folded by the above-described folding device 31.

In the sheet adhering apparatus 1a, a conveyance path R3 serving as a return conveyance path for returning the folded sheet P to the fixing apparatus 6 is arranged. The conveyance path R3 includes conveyance rollers 11 with conveyance rollers 11a, conveyance rollers 11b, and conveyance rollers 11c. The conveyance rollers 11 in the conveyance path R3 are controlled by the control unit 4 and form the conveyance path R3 for conveying and returning the folded sheet P to the fixing apparatus 6. In other words, the folded sheet P is conveyed to the fixing apparatus 6 again through the conveyance path R3.

The fixing apparatus 6 executes adhesive processing on the folded sheet P (executes a second round of thermal fixation on the powder adhesive Tn), so that the sheet P is adhered in a folded state. In other words, when the sheet P passes through the fixing nip 6n, the powder adhesive Tn on the sheet P is pressurized in a state where the powder adhesive Tn is heated and softened again. The powder adhesive Tn on the adhesive surfaces (i.e., surfaces where the powder adhesive Tn is applied, facing each other in a folded state) is closely adhered to each other. When the powder adhesive Tn is cooled and hardened, the sheet P is thereby adhered (pressure-sealed) with the adhesive (powder adhesive Tn).

The conveyance path of the sheet P having been subjected to adhesive processing by the fixing apparatus 6 is switched to the conveyance path R2. The sheet P conveyed through the conveyance path R2 is discharged from the discharge port 12 and stacked on the discharge tray 35.

### (Process Cartridge)

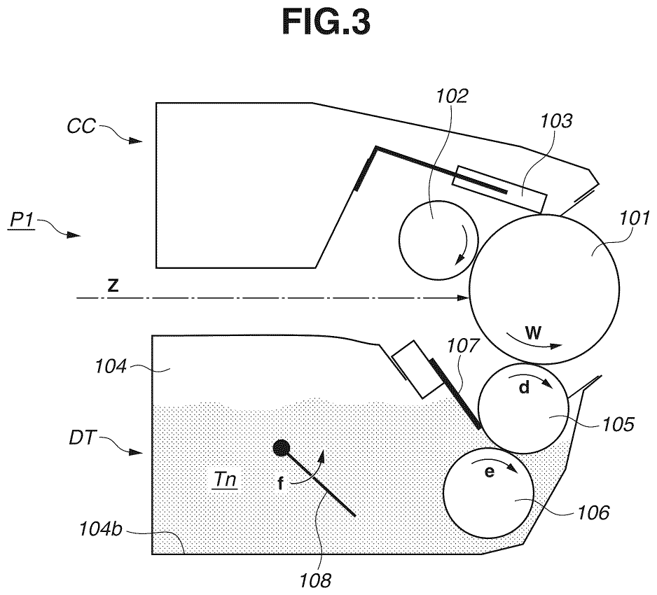

A process cartridge P1 will now be described in detail. FIG. 3 is a cross-sectional diagram illustrating a schematic configuration of the process cartridge P1. The process cartridge P1 is controlled by the control unit 4, and the process cartridge P1 includes a photosensitive unit CC including the photosensitive drum 101 and a development unit DT including the development roller 105.

The photosensitive drum 101 serving as a drum-shaped electrophotographic photosensitive member is attached to the photosensitive unit CC in a rotatable state via a shaft bearing (not illustrated). When electrophotographic processing is executed, the photosensitive drum 101 is rotationally driven in a counterclockwise direction (indicated by an arrow W) in FIG. 3 by receiving a driving force from a motor serving as a not illustrated driving unit (driving source) arranged in the body of the sheet adhering apparatus 1a. The photosensitive unit CC further includes a charging roller 102 serving as a charging unit for electrically charging the photosensitive drum 101 and a cleaning member 103 serving as a cleaning unit for cleaning a surface of the photosensitive drum 101, arranged in a periphery of the photosensitive drum 101.

The development unit DT includes the development roller 105 serving as a developer bearing member, which is in contact with the photosensitive drum 101 and rotates in a clockwise direction (indicated by an arrow d) in FIG. 3. The development roller 105 and the photosensitive drum 101 respectively rotate such that surfaces of the development roller 105 and the photosensitive drum 101 move in the same direction at a confronting portion (contact portion). The development roller 105 functions as a development unit for developing an electrostatic latent image formed on the photosensitive drum 101 by using the powder adhesive Tn serving as developer.

Further, a developer supply roller (hereinafter, simply referred to as “supply roller 106”) serving as a developer supply member, rotating in the clockwise direction (indicated by an arrow e) in FIG. 3, is further arranged on the development unit DT. The supply roller 106 and the development roller 105 respectively rotate such that surfaces of the supply roller 106 and the development roller 105 move in the same direction at a confronting portion (contact portion). The supply roller 106 supplies a powder adhesive Tn to the development roller 105. At the same time, the supply roller 106 functions to remove the powder adhesive Tn remaining on the development roller 105 from the development roller 105. In the development unit DT, a development blade 107 serving as a developer regulation member, which regulates a layer thickness of the powder adhesive Tn supplied to the development roller 105 from the supply roller 106, is arranged.

The powder containing unit 104 contains the powder adhesive Tn as a powder. In the powder containing unit 104, a conveyance member 108 supported in a rotatable state is also arranged. The conveyance member 108 rotates in the counterclockwise direction (indicated by an arrow f) in FIG. 3 to agitate the powder adhesive Tn contained in the powder containing unit 104, and conveys the powder adhesive Tn to the development roller 105 and the supply roller 106.

Herein, the photosensitive unit CC and the development unit DT can also be provided as separate units, e.g., a photosensitive unit cartridge and a development unit cartridge, removably mounted in the body of the sheet adhering apparatus 1a. Further, separately from a process cartridge which includes a photosensitive member and a developer bearing member, a powder cartridge which only includes the powder containing unit 104 and the conveyance member 108 can be mounted in the body of the sheet adhering apparatus 1a in a removable state.

### (Powder Adhesive)

A powder that contains thermoplastic resin can be used as the powder adhesive Tn of the present embodiment. The thermoplastic resin is not limited in particular. Thus, known thermoplastic resin can be contained, such as polyester resin, vinyl resin, acrylic resin, styrene-acrylic resin, polyethylene, polypropylene, polyolefin, ethylene-vinyl acetate copolymer, and ethylene-acrylic acid copolymer. The powder may also contain a plurality of types of resin described above.

Further, the powder adhesive Tn desirably contains wax. Known wax, e.g., esters of alcohols and acids called ester wax and hydrocarbon wax such as paraffin wax can be used.

The powder adhesive Tn may also contain a colorant. Known colorants, e.g., colorants for black, yellow, magenta, and cyan, can be used. It is desirable that an amount of colorant contained in the powder adhesive Tn be 1.0 weight percent (wt %) or less, and more desirably, the amount of colorant be 0.1 wt % or less. The powder adhesive Tn may also contain a magnetic material, a charge control agent, and an external additive.

To form an adhesive area (adhesive portion) on the sheet P through an electrophotographic method using the powder adhesive Tn, it is desirable that a weight-average particle diameter of the powder adhesive Tn be 5.0 micrometer (μm) or more and 30 μm or less, and more desirably, the weight-average particle diameter be 6.0 μm or more and 20 μm or less. In addition, printer toner can also be used as the powder adhesive Tn as long as adhesiveness is satisfied.

### (Sheet Adhesive Processing)

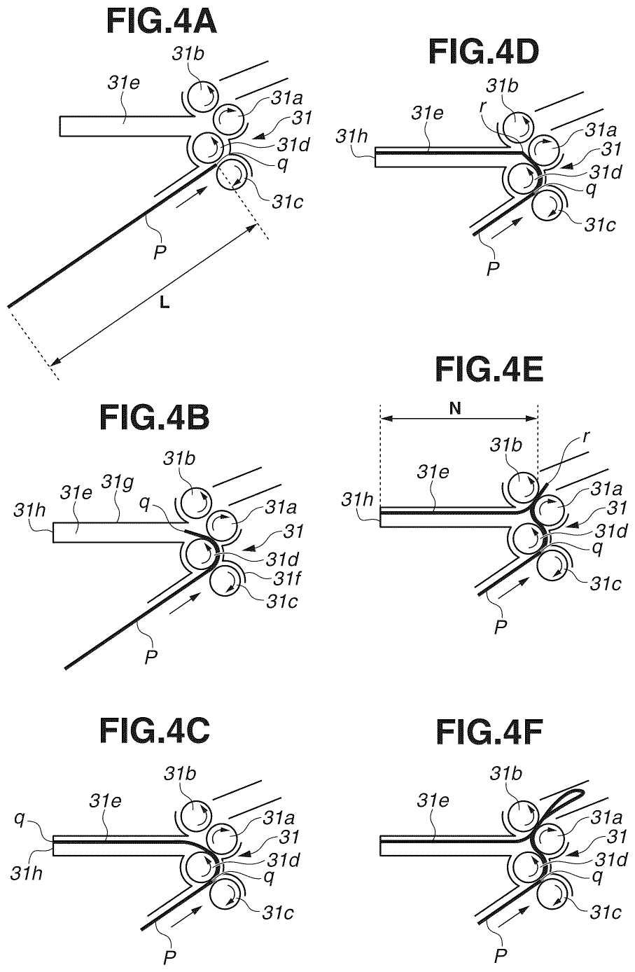

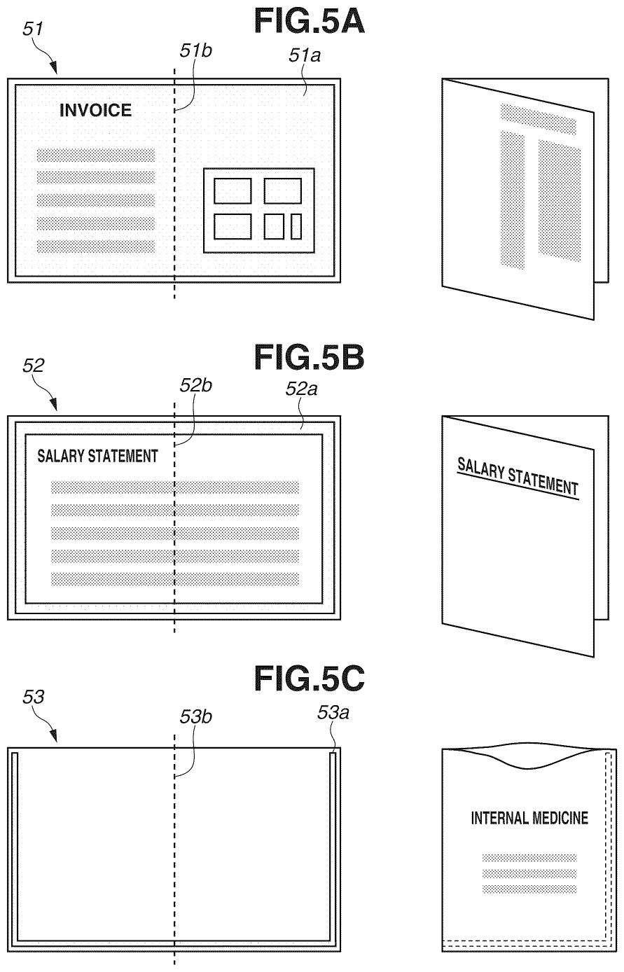

Next, the sheet adhesive processing executed by the sheet adhering apparatus 1a of the present embodiment will be described with reference to FIGS. 1 to 5C. FIGS. 4A to 4F are diagrams illustrating the content of folding processing. FIGS. 5A to 5C are diagrams illustrating adhered products output by the sheet adhering apparatus 1a.

When the products such as a pressure-sealed postcard and a salary statement are created by using the sheet adhering apparatus 1a of the present embodiment, first, preprinted paper on which information is previously printed is set to the sheet cassette 8 as a sheet P. At this time, the sheet P is set in a state where an adhesive surface is facing upward (the upper side of the apparatus).

First, data having an application pattern of the powder adhesive Tn to be printed and an execution instruction of sheet adhesive processing are input to the sheet adhering apparatus 1a from an external personal computer (not illustrated) or the like via the control unit 4. The control unit 4 of the sheet adhering apparatus 1a applies the powder adhesive Tn to the sheet P according to the specified application pattern and executes fixing processing by the fixing apparatus 6 while conveying the sheet P. Thereafter, the control unit 4 starts executing a series of processing (sheet adhesive processing) including folding processing by the folding device 31, sheet returning processing by the conveyance path R3 serving as a return conveyance path, and adhesive processing by the fixing apparatus 6.

In the sheet adhesive processing, first, as illustrated in FIG. 1, sheets P are fed from the sheet cassette 8 one by one and conveyed toward the transfer nip 3n via the conveyance rollers 8a. In parallel with feeding of the sheets P, the photosensitive drum 101 of the process cartridge P1 is rotationally driven in the counterclockwise direction (indicated by an arrow W) in FIG. 1. The surface of the photosensitive drum 101 is uniformly charged by the charging roller 102. Further, the scanner unit 2 forms an electrostatic latent image on the surface of the photosensitive drum 101 of the process cartridge P1 by irradiating the photosensitive drum 101 with laser light Z based on the application pattern. Next, the electrostatic latent image formed on the photosensitive drum 101 is developed as a powder adhesive Tn image with the powder adhesive Tn borne by the development roller 105 of the process cartridge P1. In other words, the powder adhesive Tn is adhered to an area on the surface of the photosensitive drum 101 corresponding to the application pattern for applying the powder adhesive Tn to the sheet P.

The powder adhesive Tn image formed on the photosensitive drum 101 is transferred to the sheet P at a transfer nip 3n between the photosensitive drum 101 and the transfer roller 3. Through the above processing, the electrophotographic unit G1 has applied (transferred) the powder adhesive Tn to the sheet P.

Thereafter, the sheet P is conveyed to the fixing apparatus 6 to be submitted to thermal fixation processing. In other words, the powder adhesive Tn image formed on the sheet P is heated and pressurized when the sheet P passes through the fixing nip 6n, so that the powder adhesive Tn is melted and firmly adhered to the sheet P eventually. As a result, the powder adhesive Tn is fixed to a preprinted face of the sheet P. The fixation of the powder adhesive Tn refers to a situation in which particles of the powder adhesive Tn, which are transferred to and borne on the sheet P by an electrostatic force, are melted by heat and pressure and then fixed, and thereby firmly adhered to the sheet P eventually, so that the powder adhesive Tn cannot easily be removed from the surface of the sheet P even if a mechanical external force is applied to the sheet P.

The switching member 15a switches the conveyance destination of the sheet P discharged from the fixing apparatus 6, so that the sheet P is conveyed to the folding device 31 through the conveyance path R1.

The folding device 31 includes four rollers, i.e., a first guide roller 31c, a second guide roller 31d, a first folding roller 31a, and a second folding roller 31b, and a draw-in portion 31e.

The first guide roller 31c and the second guide roller 31d are a pair of guide rollers which hold and convey the sheet P received from a conveyance path on the upstream side of the folding device 31. The first folding roller 31a and the second folding roller 31b are a pair of folding rollers that conveys the sheet P while folding the sheet P.

Steps of processing for folding a sheet P executed by the folding device 31 are illustrated in FIGS. 4A to 4F. The folding device 31 executes folding processing such that a surface where the powder adhesive Tn is applied is folded inward (facing surfaces when folded).

As illustrated in FIG. 4A, in a case where folding processing is executed, the first guide roller 31c and the first folding roller 31a rotate in the clockwise direction in FIG. 4A, and the second guide roller 31d and the second folding roller 31b rotate in the counterclockwise direction in FIG. 4A. First, a leading end q of the sheet P is drawn by the pair of guide rollers 31c and 31d. As illustrated in FIG. 4B, the leading end q of the sheet P is guided upward by a guide wall 31f, and is in contact with the first folding roller 31a. Then, the leading end q is drawn by the first folding roller 31a and the second guide roller 31d arranged to face each other, so that the leading end q is in contact with a wall 31g of the draw-in portion 31e.

When the sheet P is continuously drawn by the pair of guide rollers 31c and 31d, the leading end q further moves inside the draw-in portion 31e while rubbing against the wall 31g. Eventually, as illustrated in FIG. 4C, the leading end q abuts on an end portion 31h of the draw-in portion 31e. At this stage illustrated in FIG. 4C, the sheet P winds around the second guide roller 31d to curve in a U-shape.

From the state illustrated in FIG. 4C, when the sheet P is further drawn by the pair of guide rollers 31c and 31d, the sheet P warps at a middle portion r as illustrated in FIG. 4D. Then, as illustrated in FIG. 4E, the middle portion r is in contact with the second folding roller 31b, so that the sheet P is drawn in the nip portion between the pair of folding rollers 31a and 31b because of the frictional force received from the second folding roller 31b. Then, as illustrated in FIG. 4F, in a state where the sheet P is folded at the middle portion r as a folding line, the sheet P is discharged by the pair of folding rollers 31a and 31b with the middle portion r as a head.

In the present embodiment, a depth N (see FIG. 4E) of the draw-in portion 31e, i.e., a distance from the nip portion of the pair of folding rollers 31a and 31b to the end portion 31h of the draw-in portion 31e is set to a length half the entire length L of the sheet P. The folding device 31 can thereby execute folding (center fold) processing for folding the sheet P in half. In addition, it is possible to optionally change a position of the folding line by changing the depth N of the draw-in portion 31e.

The above-described folding device 31 is one example of a folding unit. For example, a folding mechanism that forms a folding line by pressing a blade against the sheet P and pushing the sheet P into the nip portion of a roller pair may also be used. Further, folding processing is not limited to half-folding processing. For example, a folding mechanism that executes Z-folding or three-folding processing may also be used. Because the folding device 31 according to the present embodiment is configured of rotatable rollers and the fixed draw-in portion 31e, a driving mechanism can be simplified when compared to a folding mechanism that uses a reciprocal motion blade. Further, the folding device 31 of the present embodiment can be reduced in size because the folding device 31 only includes the draw-in portion 31e having the depth N half the length L of the sheet P in addition to the four rollers.

As illustrated in FIG. 1, a sheet P folded by the folding device 31 is conveyed to the conveyance path R3.

The conveyance path R3 includes conveyance rollers 11 consisting of conveyance rollers 11a, conveyance rollers 11b, and conveyance rollers 11c. The conveyance rollers 11 receive a sheet P from a conveyance path on the upstream side, and hold and convey the sheet P to a conveyance path on the downstream side. As described above, the conveyance path R3 forms a return conveyance path that conveys and returns the folded sheet P to the fixing apparatus 6.

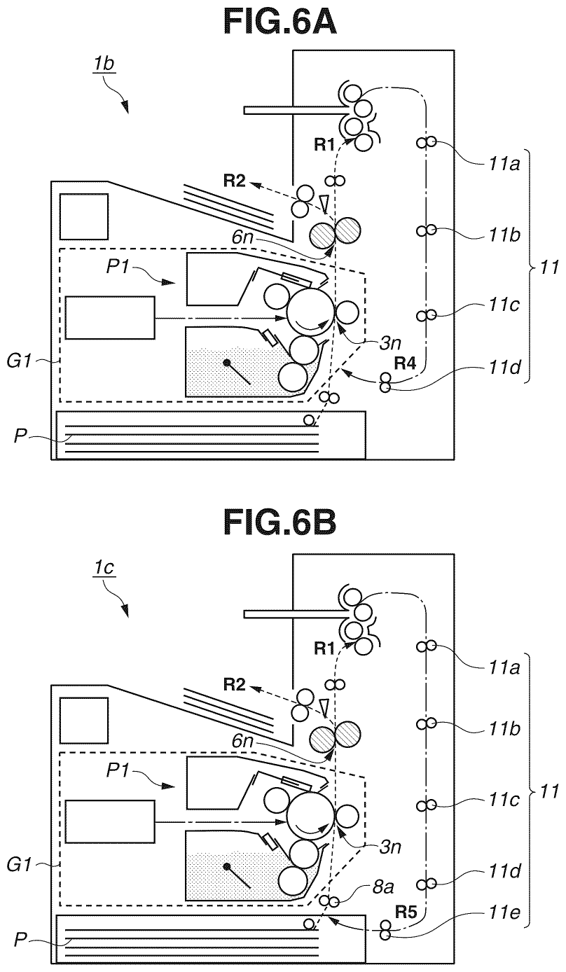

The above-described conveyance path R3 is one example of a return conveyance path. Thus, a return destination of the sheet P is not limited to the fixing apparatus 6, and the sheet P can be returned to any conveyance path on the upstream side of the fixing apparatus 6. Other examples of the return conveyance path are illustrated in FIGS. 6A and 6B. FIG. 6A is a schematic diagram illustrating a cross-sectional configuration of a sheet adhering apparatus 1b including a conveyance path R4. In FIG. 6A, the conveyance path R4 is a return conveyance path including conveyance rollers 11 consisting of conveyance rollers 11a, conveyance rollers 11b, conveyance rollers 11c, and conveyance rollers 11d. The conveyance path R4 in FIG. 6A conveys and returns a sheet folded by the folding device 31 to a conveyance path on the upstream side of the transfer nip 3n of the process cartridge P1. FIG. 6B is a schematic diagram illustrating a cross-sectional configuration of a sheet adhering apparatus 1c including a conveyance path R5. In FIG. 6B, the conveyance path R5 is a return conveyance path including conveyance rollers 11 consisting of conveyance rollers 11a, conveyance rollers 11b, conveyance rollers 11c, conveyance rollers 11d, and conveyance rollers 11e. The conveyance path R5 in FIG. 6B conveys and returns a sheet folded by the folding device 31 to a conveyance path on the upstream side of the conveyance rollers 8a. Even in the configurations illustrated in FIGS. 6A and 6B, the sheet P can also be returned to a conveyance path on the upstream side of the fixing apparatus 6.

In FIG. 1, the fixing apparatus 6 executes adhesive processing on the sheet P returned to the fixing apparatus 6 through the conveyance path R3 (executes a second round of thermal fixation on the powder adhesive Tn), so that the sheet P is adhered in a folded state. In other words, when the sheet P passes through the fixing nip 6n, the powder adhesive Tn on the sheet P is pressurized in a state where the powder adhesive Tn is heated and softened again. The powder adhesive Tn on the adhesive surfaces (i.e., surfaces where the powder adhesive Tn is applied, facing each other in a folded state) is thereby closely adhered to each other. When the powder adhesive Tn is cooled and hardened, the sheet P is thereby adhered (pressure-sealed) with the adhesive (i.e., the powder adhesive Tn).

The switching member 15a switches a conveyance destination of the sheet P, having been processed by the fixing apparatus 6 through adhesive processing, to the conveyance path R2. The sheet P, having been conveyed to the conveyance path R2, is discharged from the discharge port 12 and stacked on the discharge tray 35.

Through the above-described processing, the powder adhesive Tn is fixed by the fixing apparatus 6 after being applied to the sheet P, and the sheet P is folded by the folding device 31. Then, the folded sheet P is conveyed to the fixing apparatus 6 again through the conveyance path R3 serving as a return conveyance path, so that an adhered product can be created.

In addition, an adhesive area (adhesive portion) of the folded sheet P can be changed depending on the application pattern of the powder adhesive Tn set to the sheet P. FIGS. 5A to 5C are diagrams illustrating examples of adhered products in different application patterns of the powder adhesive Tn, which are output from the sheet adhering apparatus. FIGS. 5A and 5B illustrate examples of adhered products (semi-adhered products) to be opened by a recipient. With respect to a pressure-sealed postcard 51 illustrated in FIG. 5A, the powder adhesive Tn is applied to an area 51a on one side of a base sheet, and the base sheet is adhered in a state where the base sheet is folded at a central folding line 51b. With respect to a salary statement 52 illustrated in FIG. 5B, the powder adhesive Tn is applied to an outer circumferential area 52a on one side of a base sheet, and the base sheet is adhered in a state where the base sheet is folded at a central folding line 52b. FIG. 5C illustrates a bag (medicine bag) as an example of the adhered product (full-adhered product) not intended to be opened. In this case, the powder adhesive Tn is applied to a squared U-shape area 53a, so that a sheet is folded at a central folding line 53b and adhered to each other at two sides other than the folding line 53b.

As described above, in the present embodiment, after the fixing apparatus 6 executes fixing processing, the sheet P is folded by the folding device 31, and the folded sheet P is conveyed through the conveyance path R3, so that the fixing apparatus 6 executes adhesive processing again. Fixing processing and adhesive processing can thereby be executed by one fixing apparatus, so that the number of heating apparatuses can be reduced. As a result, while a sheet adhering apparatus using two heating apparatuses for fixing and adhesive processing may use a large amount of electric power, a sheet adhering apparatus using one heating apparatus may not use extra start-up electric power. It is thereby possible to save power consumption. Further, the size of the sheet adhering apparatus can also be reduced because the number of heating apparatuses is reduced.

### Second Embodiment

A second embodiment is different from the first embodiment in that a sheet adhering apparatus conveys a sheet P having passed through the fixing apparatus 6 to the folding device 31 by switching back the sheet P.

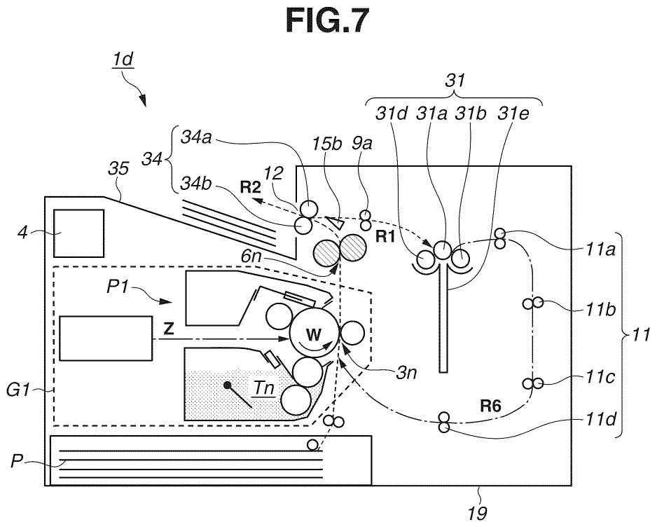

A conveyance path of a sheet P according to the present embodiment will be described with reference to FIG. 7. FIG. 7 is a schematic diagram illustrating a cross-sectional configuration of a sheet adhering apparatus 1d according to the present embodiment. A sheet P having passed through the fixing apparatus 6 is conveyed to a conveyance path R2 by a switching member 15b, so that a leading end of the sheet P is discharged to a discharge tray 35, and a trailing end of the sheet P is held by discharge rollers 34a and 34b. In this state, the discharge rollers 34a and 34b stop rotating, and the discharge rollers 34a and 34b start rotating backward. Thus, the sheet P is switched back and conveyed to the inner side of the sheet adhering apparatus 1d. The switching member 15b switches the conveyance destination of the sheet P conveyed to the inner side of the sheet adhering apparatus 1d, so that the sheet P is conveyed to the conveyance path R1. The sheet P having been conveyed through the conveyance path R1 is folded by the folding device 31 and conveyed to a conveyance path R6. The conveyance path R6 is a return conveyance path including conveyance rollers 11 consisting of conveyance rollers 11a, conveyance rollers 11b, conveyance rollers 11c, and conveyance rollers 11d. The folded sheet P is conveyed and returned to a conveyance path on the upstream side of the fixing nip 6n of the fixing apparatus 6 again through the conveyance path R6.

According to the present embodiment, the sheet P having passed through the fixing apparatus 6 is switched back, and thereby the folding device 31 and the fixing apparatus 6 can efficiently be arranged side by side. Thus, a height of the housing 19 can be reduced.

### Third Embodiment

A third embodiment will be described with respect to a case where fixing processing for fixing a powder adhesive Tn to a sheet P by the fixing apparatus 6 is executed in a first heating mode, whereas adhesive processing for adhering a folded sheet P by the fixing apparatus 6 is executed in a second heating mode, and a heating temperature in the second heating mode is set to a temperature higher than a heating temperature in the first heating mode.

In the present embodiment, thick paper having a basis weight of 105 g/m² or more is used as a sheet P. Because a thickness of the sheet P is increased, heat is not easily transferred to the sheet P. As a result, the powder adhesive Tn on the sheet P does not melt easily. There was a case where sufficient adhesiveness could not be acquired because the powder adhesive Tn on the sheet P did not melt easily. Thus, in the present embodiment, a setting temperature for the first heating mode was set to 160° C. (degrees Celsius) (first temperature), and a setting temperature for the second heating mode was set to 200° C. (second temperature). Specifically, the respective setting temperatures were adjusted by the control unit 4 of the sheet adhering apparatus 1a by controlling the heating roller 6a. By setting a setting temperature for the second heating mode to a temperature higher than a setting temperature for the first heating mode, even if thick paper is used as the sheet P, the powder adhesive Tn on the sheet P melts easily, so that sufficient sheet adhesiveness can be acquired.

### Comparative Examples

Comparative experimental results acquired by changing the setting temperature for the second heating mode are illustrated in Table 1. Adhesion strength when force was applied in a direction for pulling apart an adhered sheet was evaluated. Then, the adhesion strength was evaluated as “good (∘)” if a sheet was adhered firmly, evaluated as “fair (4)” if a sheet was adhered but was pulled apart easily, and evaluated as “poor (x)” if a sheet was not adhered. While favorable results were acquired (i.e., evaluated as “∘”) in the third embodiment and the comparative example 1, the adhesive surfaces were pulled apart (i.e., evaluated as “Δ”) in the comparative example 2. The adhesive surfaces were not adhered to each other (i.e., evaluated as “x”) in the comparative examples 3 and 4.

When the setting temperature for the first heating mode was increased, the powder adhesive Tn on the sheet P melted excessively, causing occurrence of phenomena such as offset and winding of a sheet P around a fixing roller. Further, because a setting temperature for the heating roller 6a was increased more than necessary, it was difficult to save power consumption. Thus, a temperature for the first heating mode was kept at 160° C., and only a temperature for the second heating mode was changed.

The configuration according to the third embodiment makes it possible to acquire sufficient adhesiveness while reducing a size and consumption power even if thick paper is used for a sheet P.

TABLE 1
Comparative Experimental Results

| | Third | Comparative | Comparative | Comparative | Comparative |
|---|---|---|---|---|---|
| | Embodiment | Example 1 | Example 2 | Example 3 | Example 4 |
| Setting | 160 | 160 | 160 | 160 | 160 |
| Temperature | | | | | |
| for The First | | | | | |
| Heating Mode | | | | | |
| (° C.) | | | | | |
| Setting | 200 | 190 | 180 | 170 | 160 |
| Temperature | | | | | |
| for The | | | | | |
| Second | | | | | |
| Heating Mode | | | | | |
| (° C.) | | | | | |
| Evaluation | ∘ | ∘ | Δ | x | x |
| Result of | | | | | |
| Adhered | | | | | |
| Thick Paper | | | | | |

### Fourth Embodiment

A fourth embodiment will be described with respect to a case where fixing processing for fixing a powder adhesive Tn to a sheet P by the fixing apparatus 6 is executed in a first heating mode, whereas adhesive processing for adhering a folded sheet P by the fixing apparatus 6 is executed in a second heating mode, and a processing speed for the second heating mode is set to a speed slower than a processing speed for the first heating mode.

In the present embodiment, thick paper having a basis weight of 105 g/m² or more is used as a sheet P. Because a thickness of the sheet P is increased, heat is not easily transferred to the sheet P. As a result, the powder adhesive Tn on the sheet P does not melt easily. There was a case where sufficient adhesiveness could not be acquired because the powder adhesive Tn on the sheet P did not melt easily. Thus, in the present embodiment, a processing speed for the first heating mode was set to 140 millimeters per second (mm/sec) (first speed), and a processing speed for the second heating mode was set to 90 mm/sec (second speed). Specifically, the respective processing speeds were adjusted by the control unit 4 of the sheet adhering apparatus 1a by controlling the circumferential speeds of the heating roller 6a and the pressure roller 6b.

By setting a processing speed for the second heating mode to a speed slower than a processing speed for the first heating mode, an amount of heat received by the paper per unit time is increased. Thus, even if thick paper is used as the sheet P, the powder adhesive Tn on the sheet P melts easily, so that sufficient sheet adhesiveness is acquired.

### Comparative Example

Comparative experimental results acquired by changing the processing speed of the second heating mode are illustrated in Table 2. Adhesion strength when force was applied in a direction for pulling apart an adhered sheet was evaluated. Then, the adhesion strength was evaluated as “good (∘)” if a sheet was adhered firmly, evaluated as “fair (Δ)” if a sheet was adhered but was pulled apart easily, and evaluated as “poor (x)” if a sheet was not adhered. While favorable results were acquired (i.e., evaluated as “∘”) in the fourth embodiment and the comparative example 1, the adhesive surfaces were pulled apart (i.e., evaluated as “Δ”) in the comparative example 2. The adhesive surfaces were not adhered to each other (i.e., evaluated as “x”) in the comparative examples 3 and 4.

In addition, when a processing speed for the first heating mode was also reduced, productivity of the sheet adhering apparatus 1a was lowered. Therefore, a processing speed for the first heating mode was kept at 140 mm/sec, and only a processing speed for the second heating mode was changed.

The configuration according to the fourth embodiment makes it possible to acquire sufficient adhesiveness while reducing a size and consumption power even if thick paper is used for a sheet P.

TABLE 2
Comparative Experimental Results

| | Fourth | Comparative | Comparative | Comparative | Comparative |
|---|---|---|---|---|---|
| | Embodiment | Example 1 | Example 2 | Example 3 | Example 4 |
| Processing | 140 | 140 | 140 | 140 | 140 |
| Speed for The | | | | | |
| First Heating | | | | | |
| Mode | | | | | |
| (mm/sec) | | | | | |
| Processing | 90 | 80 | 100 | 120 | 140 |
| Speed for The | | | | | |
| Second | | | | | |
| Heating | | | | | |
| Mode | | | | | |
| (mm/sec) | | | | | |
| Evaluation | ∘ | ∘ | Δ | x | x |
| Result of | | | | | |
| Adhered | | | | | |
| Thick Paper | | | | | |

### Fifth Embodiment

A fifth embodiment will be described with respect to a case where fixing processing for fixing a powder adhesive Tn to a sheet P by the fixing apparatus 6 is executed in a first heating mode, whereas adhesive processing for adhering a folded sheet P by the fixing apparatus 6 is executed in a second heating mode, and a pressure force applied to the sheet P from the pressure roller 6b in the second heating mode is greater than a pressure force in the first heating mode.

In the present embodiment, thick paper having a basis weight of 105 g/m² or more is used as a sheet P. Because a thickness of the sheet P is increased, heat is not easily transferred to the sheet P. As a result, the powder adhesive Tn on the sheet P does not melt easily. There was a case where sufficient adhesiveness could not be acquired because the powder adhesive Tn on the sheet P did not melt easily. Thus, in the present embodiment, pressure applied by the pressure roller 6b in the first heating mode was set to 13 kilogram-force (kgf) (first pressure), and pressure applied by the pressure roller 6b in the second heating mode was set to 17 kgf (second pressure).

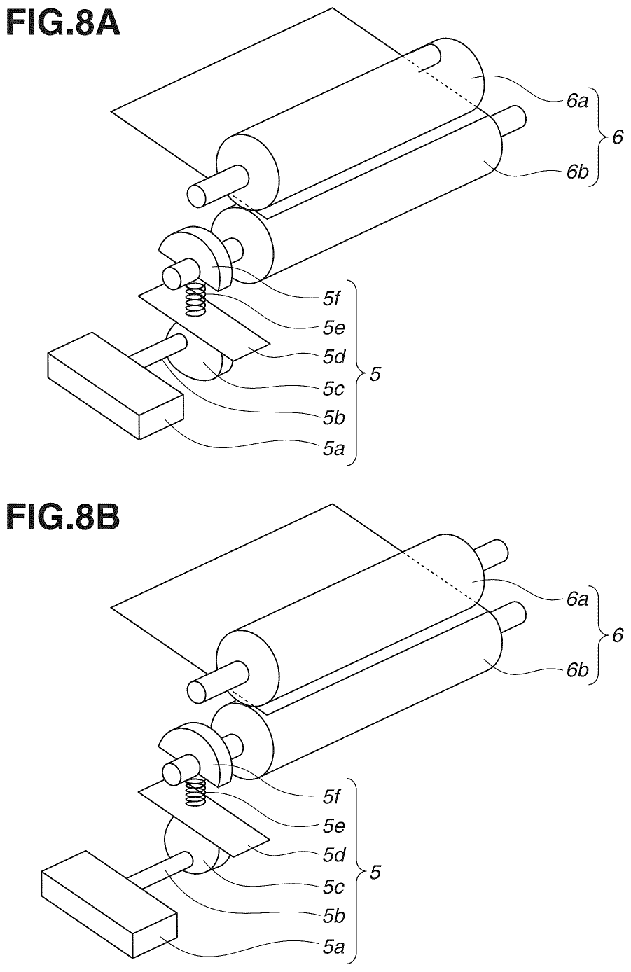

An adjustment method of the pressure applied by the pressure roller 6b will be described with reference to FIGS. 8A and 8B. In FIG. 8A, a pressure value changing apparatus 5 arranged in the fixing apparatus 6 includes a cam driving motor 5a, a camshaft 5b, a cam 5c, a pressure spring washer 5d, a pressure spring 5e, and a pressure spring bearing shaft 5f. The camshaft 5b arranged in the pressure value changing apparatus 5 is fixed to the cam 5c in a state where the camshaft 5b becomes eccentric to the center of the cam 5c. Thus, the pressure spring washer 5d mounted on the cam 5c moves up and down when the cam driving motor 5a is driven. With this movement, the pressure spring 5e attached to the pressure spring bearing shaft 5f and the pressure spring washer 5d expands and contracts to make the pressure spring bearing shaft 5f move up and down. As a result, the pressure roller 6b moves up and down, so that a value of pressure applied by the pressure roller 6b is changed. FIG. 8B illustrates a state where the cam driving motor 5a is driven to make the pressure spring 5e be compressed.

In addition, the pressure value changing apparatus 5 according to the present embodiment is merely an example, and is not intended to limit the present embodiment. Thus, any method is employed as long as pressure applied by the pressure roller 6b can be adjusted.

The pressures applied by the pressure roller 6b in the first heating mode and the second heating mode are set by the control unit 4 by controlling the pressure value changing apparatus 5 illustrated in FIGS. 8A and 8B. By setting the pressure applied by the pressure roller 6b in the second heating mode to pressure stronger than the pressure applied by the pressure roller 6b in the first heating mode, the powder adhesive Tn softened on the sheet P can strongly be adhered to each other. Thus, even if thick paper is used as a sheet P, the powder adhesive Tn on the sheet P is strongly adhered, so that sufficient sheet adhesiveness can be acquired.

### Comparative Example

Comparative experimental results acquired by changing a value of pressure applied by the pressure roller 6b in the second heating mode are illustrated in Table 3. Adhesion strength when force was applied in a direction for pulling apart an adhered sheet was evaluated. The adhesion strength was evaluated as “good (∘)” if a sheet was adhered firmly, evaluated as “fair (Δ)” if a sheet was adhered but was pulled apart easily, and evaluated as “poor (x)” if a sheet was not adhered. While favorable results were acquired (i.e., evaluated as “∘”) in the fifth embodiment and the comparative example 1, the adhesive surfaces were pulled apart (i.e., evaluated as “Δ”) in the comparative example 2. The adhesive surfaces were not adhered to each other (i.e., evaluated as “x”) in the comparative examples 3 and 4.

In addition, offset or the like occurred when pressure applied by the pressure roller 6b in the first heating mode was also increased. Thus, pressure applied by the pressure roller 6b in the first heating mode was kept at 13 kgf, and only pressure applied by the pressure roller 6b in the second heating mode was changed.

TABLE 3
Comparative Experimental Results

| | Fifth | Comparative | Comparative | Comparative | Comparative |
|---|---|---|---|---|---|
| | Embodiment | Example 1 | Example 2 | Example 3 | Example 4 |
| Pressure | 13 | 13 | 13 | 13 | 13 |
| Value for | | | | | |
| The First | | | | | |
| Heating | | | | | |
| Mode (kgf) | | | | | |
| Pressure | 17 | 16 | 15 | 14 | 13 |
| Value for | | | | | |
| The Second | | | | | |
| Heating | | | | | |
| Mode (kgf) | | | | | |
| Evaluation | ∘ | ∘ | Δ | x | x |
| Result of | | | | | |
| Adhered | | | | | |
| Thick Paper | | | | | |

The configuration according to the fifth embodiment makes it possible to acquire sufficient adhesiveness while reducing a size and consumption power even if thick paper is used as a sheet P.

### [Additional Remarks]

Further, disclosure of the present embodiment includes the following configuration examples and method examples.

### (Item 1)

An image forming apparatus including
a transfer unit configured to transfer a powder adhesive image to a sheet,
a fixing unit configured to fix a powder adhesive image that has been transferred to a sheet by the transfer unit by applying heat to the powder adhesive image, and
a folding unit configured to fold a sheet having passed through the fixing unit,
wherein the image forming apparatus includes a conveyance path configured to convey a sheet on which a powder adhesive image has been fixed to the fixing unit after the sheet has passed through the folding unit, and
wherein a folded sheet conveyed to the fixing unit through the conveyance path is heated by the fixing unit, so that the powder adhesive image fixed to the sheet develops adhesiveness to adhere surfaces of the folded sheet to each other.

### (Item 2)

The image forming apparatus according to Item 1,
wherein the transfer unit transfers a colored toner image to a sheet, and
wherein the fixing unit fixes the colored toner image transferred to the sheet by the transfer unit by heating the colored toner image.

### (Item 3)

The image forming apparatus according to Item 1 or 2, wherein the folding unit is arranged to overlap with the fixing unit when viewed in a gravitational direction.

### (Item 4)

The image forming apparatus according to any one of Items 1 to 3,
wherein the fixing unit includes a heating unit, and
wherein a first temperature of the heating unit when a sheet before being folded is heated by the fixing unit is different from a second temperature of the heating unit when a sheet after being folded is heated by the fixing unit.

### (Item 5)

The image forming apparatus according to any one of Items 1 to 4, wherein the second temperature is higher than the first temperature.

### (Item 6)

The image forming apparatus according to any one of Items 1 to 5, wherein a second speed when a sheet after being folded passes through the fixing unit is slower than a first speed when a sheet before being folded passes through the fixing unit.

### (Item 7)

The image forming apparatus according to any one of Items 1 to 6,
wherein the fixing unit applies pressure to a sheet when the sheet passing through the fixing unit is heated, and
wherein second pressure applied to a sheet passing through the fixing unit after being folded is greater than first pressure applied to a sheet passing through the fixing unit before being folded.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-044140, filed Mar. 18, 2025, which is hereby incorporated by reference herein in its entirety.

What is claimed is:

1. An image forming apparatus comprising:
a transfer unit configured to transfer a powder adhesive image to a sheet;
a fixing unit configured to fix a powder adhesive image that has been transferred to a sheet by the transfer unit by applying heat to the powder adhesive image;
a folding unit configured to fold a sheet having passed through the fixing unit; and
a conveyance path configured to convey a sheet on which a powder adhesive image has been fixed to the fixing unit after the sheet has passed through the folding unit,
wherein a folded sheet conveyed to the fixing unit through the conveyance path is heated by the fixing unit, so that the powder adhesive image fixed to the sheet develops adhesiveness to adhere surfaces of the folded sheet to each other.

2. The image forming apparatus according to claim 1,
wherein the transfer unit transfers a colored toner image to a sheet, and
wherein the fixing unit fixes the colored toner image transferred to the sheet by the transfer unit by heating the colored toner image.

3. The image forming apparatus according to claim 1, wherein the folding unit is arranged to overlap with the fixing unit when viewed in a gravitational direction.

4. The image forming apparatus according to claim 1,
wherein the fixing unit includes a heating unit, and
wherein a first temperature of the heating unit when a sheet before being folded is heated by the fixing unit is different from a second temperature of the heating unit when a sheet after being folded is heated by the fixing unit.

5. The image forming apparatus according to claim 4, wherein the second temperature is higher than the first temperature.

6. The image forming apparatus according to claim 1, wherein a second speed when a sheet after being folded passes through the fixing unit is slower than a first speed when a sheet before being folded passes through the fixing unit.

7. The image forming apparatus according to claim 1,
wherein the fixing unit applies pressure to a sheet when the sheet passing through the fixing unit is heated, and
wherein second pressure applied to a sheet passing through the fixing unit after being folded is greater than first pressure applied to a sheet passing through the fixing unit before being folded.
